(19) United States
(12) Patent Application Publication
(10) Pub. No.: US 2008/0161185 A1
(43) Pub. Date: Jul. 3, 2008

(54) Catalyst for Hydration of Vegetable Oils, Fats and Fatty Acids

(76) Inventors: Farkhat K. Khabibullin, Almaty (KZ); Yuri L. Sheludyakov, Almaty (KZ); Aleksander G. Tomilov, Almaty (KZ)

Correspondence Address: UNITED STATES DEPARTMENT OF ENERGY, 1000 INDEPENDENCE AVENUE, S.W., ATTN: GC-62 (HQ) MS 6F-067, WASHINGTON, DC, 20585-0162, US

(21) Appl. No.: 11/961,153

(22) Filed: Dec. 20, 2007

(30) Foreign Application Priority Data
Dec. 25, 2006 (KZ) 2006/1424.1

(51) Int. Cl. B01J 21/02; B01J 21/06

(52) U.S. Cl. 502/309

(57) ABSTRACT

A catalyst for hydration of vegetable oils, fats, and fatty acids based on dealkilized free nickel-titanium-chromium-iron-copper-aluminum alloy has an initial alloy additionally contains molybdenum with the following contents of components, mass %: Nickel—37.5-43.0; Titanium—1.5-3.5; Chromium—1.0-3.0; Iron—1.0-3.5; Copper—1.0-3.0; Molybdenum—1.0-3.5; Aluminum—the rest.

### CROSS-REFERENCE TO A RELATED APPLICATION

The invention described and claimed hereinbelow is also described in Kazakhstan Patent Application 2006/1424.1 filed on Dec. 25, 2006. This Kazakhstan Patent Application, whose subject matter is incorporated here by reference, provides the basis for a claim of priority of invention under 35 U.S.C. 119(a)-(d).

### BACKGROUND OF THE INVENTION

The present invention relates to organic chemistry, and in particular to catalytic hydration of vegetable oils, fats and fatty acids.

A catalyst for hydration of vegetable oils, fats and fatty acids based on dealkalized nickel-iron-copper-chromium-(or titanium)-aluminum alloy is disclosed in the Inventor's Certificate of the USSR No. 681,630. It contains the following components, in mass percent:
Nickel-35.0-46.6
Iron-1.0-5.0
Copper-1.0-5.0
Chromium (or titanium)-1.5-5.0
Aluminum, the rest

The disadvantage of this catalyst is its low activity. In particular, the activity of this catalyst expressed through a volume speed is 1.2 hour⁻¹. The experiments were performed in a column-type apparatus at temperature 200° C., hydrogen pressure 0.1 MPa, and speed of passage of excess hydrogen 120 hour⁻¹, with a cotton oil as a raw material which is hydrated to an iodine number 80% J₂.

A catalyst based on dealkalized nickel-titanium-chromium-iron-copper-aluminum alloy is disclosed in the Inventor's Certificate of the USSR No. 1,239,934 and has the following components, mass percent:
Nickel 39.5-43.0
Iron 1.0-3.0
Copper 1.0-3.0
Titanium 1.5-3.5
Chromium 1.5-3.0
Aluminum—the rest.

This catalyst has the disadvantage that it has a low activity, thermal stability or in other words retention of stable activity of catalyst during the operation over a long time in condition of high temperatures. The activity of this catalyst expressed through volume speed is 1.5 hour⁻¹. The hydration is performed in a column-type apparatus of cotton oil to iodine number 80% J₂ at temperature 200° C., hydrogen pressure 0.1 MPa, speed of passage of excess hydrogen 120 hour⁻¹, in which case the thermal stability is 420 hours.

### SUMMARY OF THE INVENTION

Accordingly, it is an object of the present invention to provide a catalyst for hydration of vegetable oils, fats and fatty acids, which has increased activity and thermal stability.

In keeping with these objects and with others which will become apparent hereinafter, one feature of the present invention resides, briefly stated, in a catalyst for hydration of vegetable oils, fats, and fatty acids based on (dealkalized) alkali-free nickel-titanium-chromium-iron-copper-aluminum alloy, wherein an initial alloy additionally contains molybdenum with the following contents of components, mass %:

| | |
|---|---|
| Nickel | 37.5-43.0 |
| Titanium | 1.5-3.5 |
| Chromium | 1.0-3.0 |
| Iron | 1.0-3.5 |
| Copper | 1.0-3.0 |
| Molybdenum | 1.0-3.5 |
| Aluminum | the rest |

### DESCRIPTION OF THE PREFERRED EMBODIMENTS

In accordance with the present invention a catalyst is proposed for hydration of vegetable oils, fats and fatty acids.

The catalyst for hydration of vegetable oils, fats, and fatty acids is based on alkali-free nickel-titanium-chromium-iron-copper-aluminum alloy, wherein an initial alloy additionally contains molybdenum with the following contents of components, mass %:

| | |
|---|---|
| Nickel | 37.5-43.0 |
| Titanium | 1.5-3.5 |
| Chromium | 1.0-3.0 |
| Iron | 1.0-3.5 |
| Copper | 1.0-3.0 |
| Molybdenum | 1.0-3.5 |
| Aluminum | the rest |

The alloy in accordance with the present invention has a molybdenum, and the above described ratio of components.

The ratio of components is very important. Results of experiment shown that reduction of content of titanium below 1.5%, of chromium below 1.0%, of iron below 1.0%, of copper below 1.0%, of molybdenum below 1.0%, of nickel below 37.5% reduces the activity of the catalyst.

Similar situation takes place with increase of content of nickel above 43.9%, of titanium above 3.5%, of chromium above 3.0%, of iron above 3.5%, of copper above 3.0%, of molybdenum above 3.5%. The proposed catalyst with the above described content of the components, taken in the above described ratio, has increased activity, thermal stability during hydration of cotton oil, castor oil, distilled fatty acids.

For example, during hydration in a column-type apparatus of cotton oil, the activity of the proposed catalyst was 1.75 hour⁻¹ at the temperature of experiment 200° C., hydrogen pressure 0.1 MPa, speed of passage of excess hydrogen 120 hour⁻¹, and the thermal stability was 505 hours.

The catalysts are obtained by melting the above listed components together with a subsequent alkali removal (dealkalization) of aluminum for obtaining an active surface.

The examples presented herein below illustrate the present invention.

### Example 1

For obtaining an alloy, aluminum (104 g, 2-3% excess for burning for obtaining in a final melt 50% of aluminum) is heated to temperature 1100-1200° C., and then 80 g of nickel is introduced. The temperature, due to exothermic reaction is elevated to 1900-2000° C. In the melt, there are introduced: 3.0 g titanium, 2.0 g chromium, 2.0 g iron, 6.0 g copper, 7.0 g molybdenum. The melt is thoroughly mixed, poured into cast iron molds, cooled with water, crushed, fractioned.

The obtained alloy contains, in mass percent:
Ni-40.0, Ti-1.5, Cr-1.0, Fe-1.10, Cu-3.0, Mo-3.5, All the rest.

### Example 2

For obtaining alloy Ni—Ti—Cr—Fe—Cu—Mo—Al (39.5:3.0:2.0:1.5:1.5:2.5:50.0), into a graphite crucible, 104 g of aluminum are introduced, and in accordance with the procedure presented in Example 1, 79.0 g nickel, 6.0 g titanium, 4.0 g chromium, 3.0 g iron, 3.0 g copper, 5.0 g molybdenum.

### Example 3

For obtaining an alloy Ni, Ti, Cr, Fe, Cu, Mo, Al (43.0:1.5:1.0:1.0:1.0:2.5:50.0), into a graphite crucibile, 104 g aluminum are introduced, and in accordance with the procedure presented in Example 1, 86.0 g nickel, 3.0 g titanium, 2.0 g chromium, 2.0 g iron, 2.0 g copper, 5.0 g molybdenum.

### Example 4

For obtaining an alloy Ni, Ti, Cr, Fe, Cu, Mo, Al (37.5:3.5:3.0:3.5:1.5:1.0:50.0), into a graphite crucible, 104 g aluminum are introduced, and in accordance with the procedure presented in Example 1, 75.0 g nickel, 7.0 g titanium, 6.0 g chromium, 6.0 g iron, 3.0 g copper, 2.0 g molybdenum.

Hydration is carried in a device of column-type and in a catalytic “bedpan”.

Hydration in the catalytic “bedpan” is carried out in standard conditions:

load of substance (cotton oil)—10 g;

load of catalyst obtained by alkali removal—1.0 g of alloy with a fraction 0.25-0.50 mm by 20% of caustic soda on boiling water bath during 120 min with a subsequent washing from caustic soda by distilled water to neutral reaction according to phenolphthalein;
temperature of reaction—200° C.;
hydrogen pressure—0.1 MPe,
speed of stirring—680-700 of one-sided tilting a minute.

For hydration, in the device of column type, 60 ml of catalyst alloy with fraction 3-5 mm is loaded into a reactor of stainless steel, alkali removal is performed with 10% caustic soda until removal from the alloy 10% of aluminum (the depth of dealkalization is controlled based on value of extracted hydrogen). The dealkalized catalyst is washed with distilled water to neutral reaction on phenolphthalein and dried in a stream of hydrogen at 120° C. The hydration is applied to cotton oil with iodine no. 105.9% J₂, acid no. 0.38 mg KOH, castor oil (iodine no. 72.8% J₂, acid no. 1.6 mg KOH), distilled fatty acids (iodine no. 99.7 J₂, acid no. 200.6 mg KOH, titre-36.5° C.) with uninterrupted supply of oil and hydrogen into the reactor at 160-200° C. and hydrogen pressure 0.1-1.5 MPa.

### Example 5

Into the catalytic “bedpan” 10 g of cotton oil is poured, air is expelled by hydrogen, and a swinging device and heating are turned on. During heating of oil to temperature 200° C. the swinging device is turned off, a load of catalyst is introduced, and a significant quantity of hydrogen is passed through until complete expelling of air. Then the pressure of 0.1 MPa is established, and the swinging device is turned on. This is the beginning of hydration. After 60 minutes the swinging device is turned off, and a sample of hydrogenated fat is taken. Fatty-acid composition of the obtained hydrogenated fat is determined. The degree of saturation is determined by iodine no.

Table 1 shows comparative data for hydrogenation of cotton oil with the use of known and proposed catalysts containing different quantities of titanium.

TABLE 1
COMPARATIVE CHARACTERISTICS OF CATALYSTS
DURING HYDRATION OF COTTON OIL

| | Iodine no. of | | | |
|---|---|---|---|---|
| | hydrogenated | Δ of iodine | Increase of | |
| Composition of catalyst, mass % | fat % J₂ | no., % J₂ | activity % | Selectivity % |
| KNOWN CATALYST | | | | |
| Ni—Ti—Cr—Fe—Cu—Al | | | | |
| 42, 0-3, 0-2, 0-1, 5-1, 5-50, 0 | 59.3 | 46.6 | 0 | 81 |
| PROPOSED CATALYST | | | | |
| Ni—Ti—Cr—Fe—Cu—Mo—Al | | | | |
| 41.5-1.0-2.0-1.5-1.5-2.5-50.0 | 56.7 | 49.2 | 5.6 | 81 |
| 41.0-1.5-2.0-1.5-1.5-2.5-50.0 | 55.9 | 50.0 | 7.3 | 81 |
| 40.0-2.5-2.0-1.5-1.5-2.5-50.0 | 53.5 | 52.4 | 12.5 | 81 |
| 39.5-3.0-2.0-1.5-1.5-2.5-50.0 | 53.3 | 52.6 | 12.9 | 80 |
| 39.0-3.5-2.0-1.5-1.5-2.5-50.0 | 56.1 | 49.8 | 6.9 | 81 |
| 38.5-4.0-2.0-1.5-1.5-2.5-50.0 | 57.6 | 48.3 | 3.7 | 81 |

The data presented in Table 1 shows that activity of proposed catalyst with optimal content of titanium 1.5-3.5% with the same selectivity is 6.9-12.9% higher than of the known catalyst.

### Example 6

The hydration is carried out in conditions analogous to the Example 5, on the proposed catalyst with a different quantity of chromium.

Comparative results are presented in Table 2.

TABLE 2
INFLUENCE OF CONTENT OF CHROMIUM ON CATALYTIC
PROPERITES OF SKELETON CATALYST

| | Iodine no. of | | | |
|---|---|---|---|---|
| | hydrogenated | Δ of iodine | Increase of | |
| Composition of catalyst, mass % | fat % J₂ | no., % J₂ | activity % | Selectivity % |
| KNOWN CATALYST | | | | |
| Ni—Ti—Cr—Fe—Cu—Al | | | | |
| 42, 0-3, 0-2, 0-1, 5-1, 5-50, 0 | 59.3 | 46.6 | 0 | 81 |
| PROPOSED CATALYST | | | | |
| Ni—Ti—Cr—Fe—Cu—Mo—Al | | | | |
| 41.0-3.0-0.5-1.5-1.5-2.5-50.0 | 56.8 | 49.1 | 5.4 | 81 |
| 40.5-3.0-1.0-1.5-1.5-2.5-50.0 | 56.0 | 49.9 | 7.3 | 81 |
| 39.5-3.0-2.0-1.5-1.5-2.5-50.0 | 53.3 | 52.6 | 12.9 | 81 |
| 38.5-3.0-3.0-1.5-1.5-2.5-50.0 | 55.9 | 50.0 | 7.3 | 81 |
| 38.0-3.0-3.5-1.5-1.5-2.5-50.0 | 57.2 | 48.7 | 4.5 | 81 |

As can be seen from FIG. 2, the activity of the proposed catalyst with optimal content of chromium 1.0-3.0% with the same selectivity is 7.1-12.9% higher than the known catalyst.

### Example 7

Hydration as carried out in conditions analogous to Example 5 of the proposed catalyst with contact of different quantities of iron.

Comparative results are presented in Table 3.

TABLE 3
INFLUENCE OF CONTENT OF IRON ON CATALYTIC
PROPERTIES OF SKELETON CATALYST

| | Iodine no. of | | | |
|---|---|---|---|---|
| | hydrogenated | Δ of iodine | Increase of | |
| Composition of catalyst, mass % | fat % J₂ | no., % J₂ | activity % | Selectivity % |
| KNOWN CATALYST | | | | |
| Ni—Ti—Cr—Fe—Cu—Al | | | | |
| 42, 0-3, 0-2, 0-1, 5-1, 5-50, 0 | 59.3 | 46.6 | 0 | 81 |
| PROPOSED CATALYST | | | | |
| Ni—Ti—Cr—Fe—Cu—Mo—Al | | | | |
| 40.5-3.0-2.0-0.5-1.5-2.5-50.0 | 57.0 | 48.9 | 4.9 | 80 |
| 40.0-3.0-2.0-1.0-1.5-2.5-50.0 | 56.1 | 49.8 | 6.9 | 80 |
| 39.5-3.0-2.0-1.5-1.5-2.5-50.0 | 53.3 | 52.5 | 12.9 | 80 |
| 38.5-3.0-2.0-2.5-1.5-2.5-50.0 | 53.6 | 52.3 | 12.3 | 80 |
| 37.5-3.0-2.0-3.5-1.5-2.5-50.0 | 55.8 | 50.1 | 7.5 | 81 |
| 37.0-3.0-2.0-4.0-1.5-2.5-50.0 | 57.1 | 48.8 | 4.7 | 81 |

As can be seen from Table 3, activity of the proposed catalyst with optimal content of iron 1.0-3.5% with the same selectivity is 6.9-12.9% higher than of the known catalyst.

### Example 8

Hydration is carried in conditions analogous to Example 5 on the proposed catalyst with different quantities of copper. Comparative results are presented in Table 4.

TABLE 4
INFLUENCE OF CONTENT OF COPPER ON CATALYTIC
PROPERTIES OF SKELETON CATALYSTS

| | Iodine no. of | | | |
|---|---|---|---|---|
| | hydrogenated | Δ of iodine | Increase of | |
| Composition of catalyst, mass % | fat % J₂ | no., % J₂ | activity % | Selectivity % |
| KNOWN CATALYST | | | | |
| Ni—Ti—Cr—Fe—Cu—Al | | | | |
| 42, 0-3, 0-2, 0-1, 5-1, 5-50, 0 | 59.3 | 46.6 | 0 | 81 |
| PROPOSED CATALYST | | | | |
| Ni—Ti—Cr—Fe—Cu—Mo—Al | | | | |
| 40.5-3.0-2.0-1.5-0.5-2.5-50.0 | 57.2 | 48.7 | 4.5 | 81 |
| 40.0-3.0-2.0-1.5-1.0-2.5-50.0 | 56.1 | 49.8 | 6.9 | 81 |
| 39.5-3.0-2.0-1.5-1.5-2.5-50.0 | 53.3 | 52.6 | 12.9 | 80 |
| 38.5-3.0-2.0-1.5-2.5-2.5-50.0 | 53.7 | 52.2 | 12.1 | 80 |
| 38.0-3.0-2.0-1.5-3.0-2.5-50.0 | 56.2 | 49.7 | 6.7 | 81 |
| 37.5-3.0-2.0-1.5-3.5-2.5-50.0 | 57.0 | 48.9 | 4.9 | 81 |

It can be seen from Table 4 the activity of the proposed catalyst with optimum of quantity of copper 1.0-3.0% with the same selectivity is 6.7-12.9% higher than of the known catalyst.

### Example 9

Hydration is carried out in conditions analogous to Example 5 of the proposed catalyst with a different quantity of molybdenum. The comparative results are presented in Table 5.

TABLE 5
INFLUENCE OF CONTENT OF MOLYBDENUM ON CATALYTIC
PROPERTIES OF SKELETON CATALYSTS

| | Iodine no. of | | | |
|---|---|---|---|---|
| | hydrogenated | Δ of iodine | Increase of | |
| Composition of catalyst, mass % | fat % J₂ | no., % J₂ | activity % | Selectivity % |
| KNOWN CATALYST | | | | |
| Ni—Ti—Cr—Fe—Cu—Al | | | | |
| 42, 0-3, 0-2, 0-1, 5-1, 5-50, 0 | 59.3 | 46.6 | 0 | 81 |
| PROPOSED CATALYST | | | | |
| Ni—Ti—Cr—Fe—Cu—Mo—Al | | | | |
| 41.5-3.0-2.0-1.5-1.5-0.5-50.0 | 57.4 | 48.5 | 4.1 | 81 |
| 41.0-3.0-2.0-1.5-1.5-1.0-50.0 | 55.8 | 50.1 | 7.5 | 81 |
| 40.5-3.0-2.0-1.5-1.5-1.5-50.0 | 54.6 | 51.3 | 10.1 | 80 |
| 39.5-3.0-2.0-1.5-1.5-2.5-50.0 | 53.5 | 52.6 | 12.9 | 80 |
| 38.5-3.0-2.0-1.5-1.5-3.5-50.0 | 55.9 | 50.0 | 7.3 | 81 |
| 38.0-3.0-2.0-1.5-1.5-4.0-50.0 | 57.0 | 48.9 | 4.9 | 81 |

The data of Table 5 show the activity of the proposed catalyst with optimal content of molybdenum 1.0-3.5% with the same selectivity as 7.3-12.9% higher than of the known catalyst.

### Example 10

Hydration is carried out in conditions analogous to Example 5 of the proposed catalyst with a different quantity of nickel. Comparative results are presented in Table 6.

TABLE 6
INFLUENCE OF CONTENT OF NICKEL ON CATALYTIC
PROPERTIES OF SKELETON CATALYSTS

| | Iodine no. of | | | |
|---|---|---|---|---|
| | hydrogenated | Δ of iodine | Increase of | |
| Composition of catalyst, mass % | fat % J₂ | no., % J₂ | activity % | Selectivity % |
| KNOWN CATALYST | | | | |
| Ni—Ti—Cr—Fe—Cu—Al | | | | |
| 42, 0-3, 0-2, 0-1, 5-1, 5-50, 0 | 59.3 | 46.6 | 0 | 81 |
| PROPOSED CATALYST | | | | |
| Ni—Ti—Cr—Fe—Cu—Mo—Al | | | | |
| 37.0-4.0-2.5-2.0-2.0-2.5-50.0 | 57.7 | 48.2 | 3.4 | 81 |
| 37.5-3.0-2.0-3.5-1.5-2.5-50.0 | 55.8 | 50.1 | 7.5 | 81 |
| 38.5-3.0-2.0-1.5-2.5-2.5-50.0 | 53.7 | 52.2 | 12.1 | 80 |
| 40.5-3.0-2.0-1.5-1.5-1.5-50.0 | 54.6 | 51.3 | 10.1 | 80 |
| 42.0-2.5-1.5-1.5-1.0-1.5-50.0 | 55.4 | 50.5 | 8.4 | 81 |
| 43.0-2.0-1.5-1.0-1.0-1.5-50.0 | 55.9 | 50.0 | 7.3 | 81 |
| 43.5-1.5-1.0-2.0-0.5-1.5-50.0 | 57.6 | 48.3 | 3.7 | 81 |

Data of Table 6 shows the activity of proposed catalyst with optimal content of nickel 37.5-43.0% with the same selectivity 7.3-12.1% higher than of the known catalyst.

### Example 11

In Table 7 there are comparative data for hydration of cotton oil to iodine no. 80% J₂ in the device of column-type at 200° C., hydrogen pressure 0.1 MPa, barbotating of hydrogen 120 hour⁻¹ with the use of known and proposed catalysts.

TABLE 7
COMPARATIVE CHARACTERISTICS OF CATALYSTS
DURING HYDRATION OF COTTON OIL

| | Volume | | |
|---|---|---|---|
| | speed of | | Thermal |
| | supply of oil, | | stability, |
| Composition of catalyst, mass % | hour⁻¹ | Selectivity, % | hour |
| KNOWN CATALYST | | | |
| Ni—Ti—Cr—Fe—Cu—Al | | | |
| 42, 0-3, 0-2, 0-1, 5-1, 5-50, 0 | 1.5 | 91 | 420 |
| PROPOSED CATALYST | | | |
| Ni—Ti—Cr—Fe—Cu—Mo—Al | | | |
| 37.5-3.5-3.0-3.5-1.5-1.0-50.0 | 1.60 | 93 | 470 |
| 39.5-3.0-2.0-1.5-1.5-2.5-50.0 | 1.75 | 94 | 505 |
| 40.0-1.5-1.0-1.0-3.0-3.5-50.0 | 1.65 | 93 | 480 |
| 43.0-1.5-1.0-1.0-1.0-2.5-50.0 | 1.60 | 93 | 465 |

The data of Table 7 show that the proposed catalyst with hydration of cotton oil is more active than the catalyst disclosed in the Inventor's Certificate of the USSR No. 1,239,934 1.07-1.17 times. In addition the thermal stability of the proposed catalyst is 7-20% higher, and the selectivity of the process is 2-3% higher.

### Example 12

In Table 8 there are comparative data of hydration of castor oil to iodine no. 8-9% J₂ at 160° C., hydrogen pressure 1.5 MPa, passage of hydrogen 300 hours⁻¹ with the use of known and proposed catalysts.

TABLE 8
COMPARATIVE CHARACTERISTICS OF CATALYSTS
DURING HYDRATION OF CASTOR OIL

| | Volume | | |
|---|---|---|---|
| | speed of | | Thermal |
| | supply of oil, | | stability, |
| Composition of catalyst, mass % | hour⁻¹ | Selectivity, % | hour |
| KNOWN CATALYST | | | |
| Ni—Ti—Cr—Fe—Cu—Al | | | |
| 42, 0-3, 0-2, 0-1, 5-1, 5-50, 0 | 0.45 | 84.1 | 200 |
| PROPOSED CATALYST | | | |
| Ni—Ti—Cr—Fe—Cu—Mo—Al | | | |
| 37.5-3.5-3.0-3.5-1.5-1.0-50.0 | 0.53 | 84.0 | 230 |
| 39.5-3.0-2.0-1.5-1.5-2.5-50.0 | 0.58 | 84.2 | 250 |
| 40.0-1.5-1.0-1.0-3.0-3.5-50.0 | 0.54 | 84.1 | 235 |
| 43.0-1.5-1.0-1.0-1.0-2.5-50.0 | 0.52 | 84.1 | 220 |

The data of Table 8 show that the proposed catalyst during hydration of castor oil is more active than catalyst in the above mentioned patent 1.16-1.29 times. The thermal stability of the proposed catalyst is 10-25% higher.

### Example 13

Table 9 shows comparative data of hydration of distilled fatty acids on the known and proposed catalysts to iodine no. 20-25% J₂ at 200° C., at hydrogen pressure 0.3 MPa, passage of hydrogen 200 hours⁻¹.

TABLE 9
COMPARATIVE CHARACTERISTICS OF CATALYSTS
DURING HYDRATION OF DISTILLED FATTY ACIDS

| | Volume | | |
|---|---|---|---|
| | speed of | | Thermal |
| | supply of oil, | | stability, |
| Content of Catalyst, Mass % | hour⁻¹ | Titer, C | hour |
| KNOWN CATALYST | | | |
| Ni—Ti—Cr—Fe—Cu—Al | | | |
| 42, 0-3, 0-2, 0-1, 5-1, 5-50, 0 | 0.85 | 51.1 | 50 |
| PROPOSED CATALYST | | | |
| Ni—Ti—Cr—Fe—Cu—Mo—Al | | | |
| 37.5-3.5-3.0-3.5-1.5-1.0-50.0 | 0.95 | 50.9 | 55 |
| 39.5-3.0-2.0-1.5-1.5-2.5-50.0 | 1.05 | 51.2 | 65 |
| 40.0-1.5-1.0-1.0-3.0-3.5-50.0 | 1.00 | 51.0 | 60 |
| 43.0-1.5-1.0-1.0-1.0-2.5-50.0 | 0.95 | 50.7 | 55 |

The proposed catalyst during hydration of distilled fatty acids, as can be seen from data of Table 9, is more active than the known catalyst 1.12-1.24 times. The thermal stability of the proposed catalyst is 10-30% higher than of the known catalyst.

The comparison of properties of known and proposed catalyst is presented in Table 10.

TABLE 10
COMPARATIVE CHARACTERISTICS OF CATALYSTS
DURING HYDRATION OF OILS AND FATTY ACIDS

Catalyst

| Parameter | Proposed | Known |
|---|---|---|
| Catalytic Activity During Hydration: | | |
| Cotton Oil | 107-117 | 100 |
| Castor Oil | 116-129 | 100 |
| Distilled Fatty Acids | 112-124 | 100 |
| Thermostability, hours: | | |
| During hydration: | | |
| Cotton Oil | 465-505 | 420 |
| Castor Oil | 220-250 | 200 |
| Distilled Fatty Acids | 55-65 | 50 |

Therefore, according to the invention, additional molybdenum, during hydration of cotton oil, is more active than the known catalyst by 7-17%, during hydration of castor oil-by 69-29%, during hydration of distilled fatty acids 1-by 12-24%. The thermal stability of the proposed catalyst during hydration of all types of initial material is 10-30% higher than of the known catalyst.

It will be understood that each of the elements described above, or two or more together, may also find a useful application in other types of catalysts differing from the type described above.

While the invention has been illustrated and described as embodied in a catalyst for hydration of vegetable oils, fats and fatty acids, it is not intended to be limited to the details shown, since various modifications and structural changes may be made without departing in any way from the spirit of the present invention.

What is claimed as new and desired to be protected by Letters Patent is set forth in the appended claims.

1. A catalyst for hydration of vegetable oils, fats, and fatty acids based on dealkalized nickel-titanium-chromium-iron-copper-aluminum alloy, wherein an initial alloy additionally contains molybdenum with the following contents of components, mass %:

| | |
|---|---|
| Nickel | 37.5-43.0 |
| Titanium | 1.5-3.5 |
| Chromium | 1.0-3.0 |
| Iron | 1.0-3.5 |
| Copper | 1.0-3.0 |
| Molybdenum | 1.0-3.5 |
| Aluminum | the rest |
